(19) United States
(12) Patent Application Publication
(10) Pub. No.: US 2015/0006537 A1
(43) Pub. Date: Jan. 1, 2015

(54) Aggregating Question Threads

(71) Applicant: International Business Machines Corporation, Armonk, NY (US)

(72) Inventors: Jana H. Jenkins, Raleigh, NC (US); David C. Steinmetz, Bothell, WA (US); Wlodek W. Zadrozny, Tarrytown, NY (US)

(21) Appl. No.: 13/928,627

(22) Filed: Jun. 27, 2013

(51) Int. Cl. G06F 17/30

(52) U.S. Cl. CPC G06F 17/30713
USPC 707/740

(57) ABSTRACT

An approach is provided in which a question thread management system accumulates a set of questions from a first user into a question thread and classifies the question thread based upon a user profile of the first user. The question thread management system receives a query request from a second user and compares request attributes included in the second user's query request with profile attributes included in first user's user profile. In turn, the question thread management system provides the question thread from the first user to the second user.

### BACKGROUND

The present disclosure relates to aggregating question threads. More particularly, the present disclosure relates to classifying question threads according to user profiles and providing the question threads on request based upon user profile attributes.

Individuals ask questions for various reasons. One question often leads to a chain of questions to learn about topics, solve problems, understand issues, etc. An individual's questions are typically based upon the individual's expertise level of a particular topic. As an individual becomes more knowledgeable about a particular topic, the individual asks increasingly complex and detailed questions.

During a question and answer session, an individual may reach a point where the individual does not know what else to ask. For example, a new doctor may be diagnosing a patient and, after asking the patient a series of questions, the doctor may be at a point where the doctor requires guidance on what else to ask the patient.

With the increased usage of computing networks, such as the Internet, individuals are inundated and overwhelmed with the amount of information available to them from various structured and unstructured sources. However, information gaps abound as individuals try to piece together what they can find that they believe to be relevant during searches for information on various subjects. To assist with such searches, recent research has been directed to generating Question and Answer (QA) systems which may take an input question, analyze it, and return results indicative of the most probable answer to the input question. QA systems provide automated mechanisms for searching through large sets of sources of content, e.g., electronic documents, and analyze them with regard to an input question to determine an answer to the question and a confidence measure as to how accurate an answer is for answering the input question.

One such QA system is the Watson™ system available from International Business Machines (IBM) Corporation of Armonk, N.Y. The Watson™ system is an application of advanced natural language processing, information retrieval, knowledge representation and reasoning, and machine learning technologies to the field of open domain question answering. The Watson™ system is built on IBM's DeepQA™ technology used for hypothesis generation, massive evidence gathering, analysis, and scoring. DeepQA™ takes an input question, analyzes it, decomposes the question into constituent parts, generates one or more hypothesis based on the decomposed question and results of a primary search of answer sources, performs hypothesis and evidence scoring based on a retrieval of evidence from evidence sources, performs synthesis of the one or more hypothesis, and based on trained models, performs a final merging and ranking to output an answer to the input question along with a confidence measure.

### BRIEF SUMMARY

According to one embodiment of the present disclosure, an approach is provided in which a question thread management system accumulates a set of questions from a first user into a question thread and classifies the question thread based upon a user profile of the first user. The question thread management system receives a query request from a second user and compares request attributes included in the second user's query request with profile attributes included in first user's user profile. In turn, the question thread management system provides the question thread from the first user to the second user.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 illustrates an information handling system, which is a simplified example of a computer system capable of performing the computing operations described herein;

FIG. 2 provides an extension of the information handling system environment shown in FIG. 1 to illustrate that the methods described herein can be performed on a wide variety of information handling systems that operate in a networked environment;

FIG. 3 depicts a diagram showing a question thread management system providing a question thread to a user based upon a requested expertise level;

FIG. 4 depicts a diagram of a user profile window that allows a user to create a user profile and enter profile attributes;

FIG. 5A depicts a diagram of a question window that allows a user to enter a question and other relevant information;

FIG. 5B depicts a diagram of an answer window that provides an answer (e.g., URL) to a question previously asked by the user;

FIG. 5C is a depiction of a question thread query window that allows a user to request a question thread based upon a particular expertise level;

FIG. 6 depicts a diagram graphically depicting question threads;

FIG. 7 is a depiction of a table that includes information accumulated into a question thread;

FIG. 8 is a depiction of a flowchart showing the logic used by the question thread management system to manage question threads; and

FIG. 9 is a depiction of a flowchart showing the logic used by the question thread management system to locate acceptable question threads to provide to a user based upon a user profile.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer, server, or cluster of servers. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

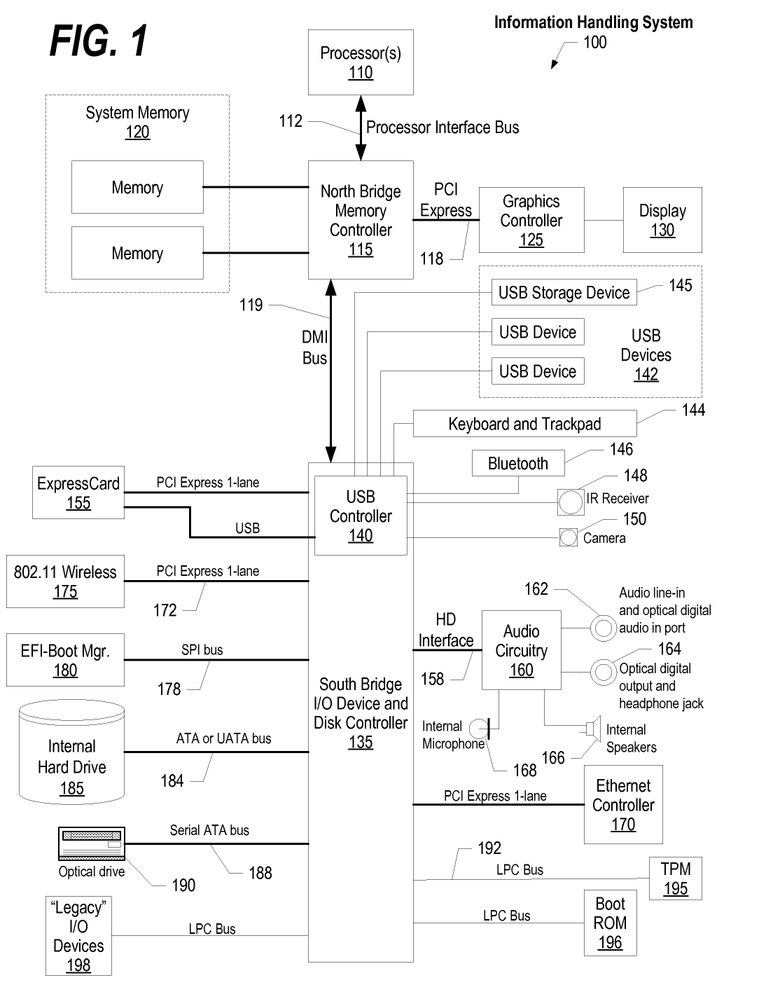

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184. ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wirelessly communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

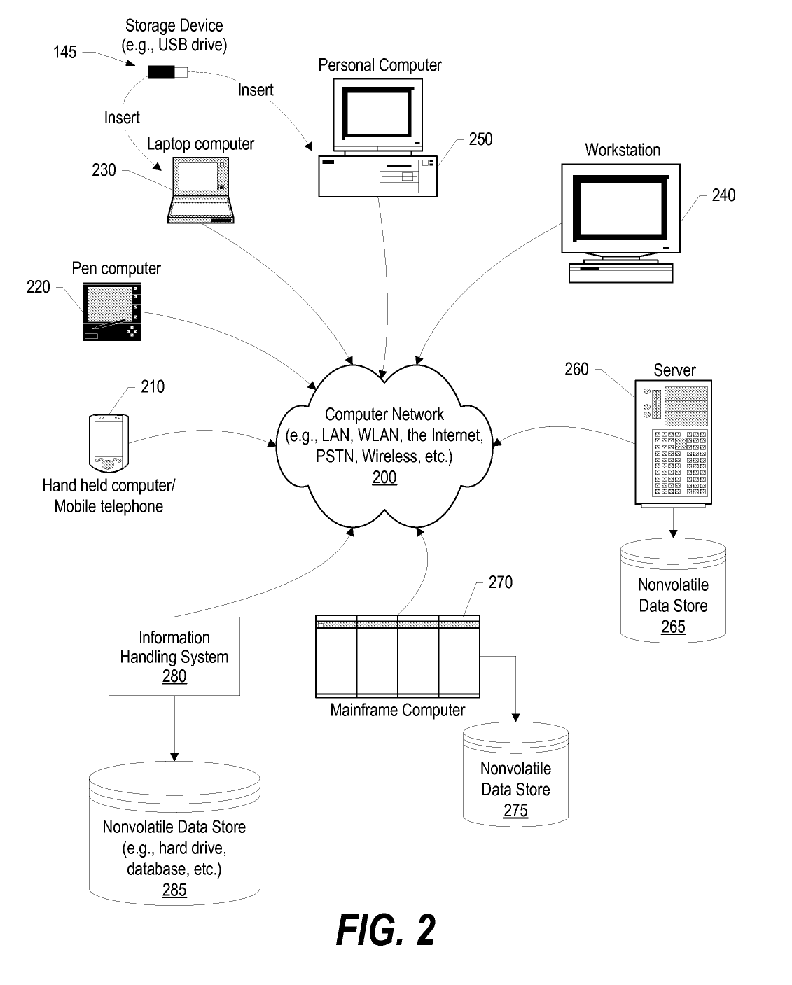

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

Question and Answer (QA) systems provide answers to input questions by ingesting a large corpus of documentary data, annotating the data, and generally processing the data before-hand to generate structured information from structured and unstructured electronic documents. With a QA system, a question is received, the QA system parses the question and analyzes it to determine what is being asked for, and then performs a search of its ingested data from the corpus to identify candidate answers for the input question, determine confidence scores for the candidate answers based on analysis of evidentiary information, and the like. If the direct answer to the question is not in the ingested corpus, the QA system cannot provide the correct answer for the input question. In these instances, the QA system provides an incorrect answer with a low confidence score. In other words, if the direct answer for the question is not present within the ingested corpus, then the QA system is not useful to answer that question.

In such a situation, the question that cannot be answered may be logged and used as a basis for human intervention to add to the corpus the document data that provides the correct answer for the question. That is, a human analyst must be informed of the lack of information in the corpus, the human analyst must locate the documents that provide the answer to the question and, if necessary, take actions to put the documents into a form that the QA system can ingest, and then cause the QA system to perform ingestion operations, including annotations by one or more annotators, and the like, in order to expand the corpus to include the answer to the input question.

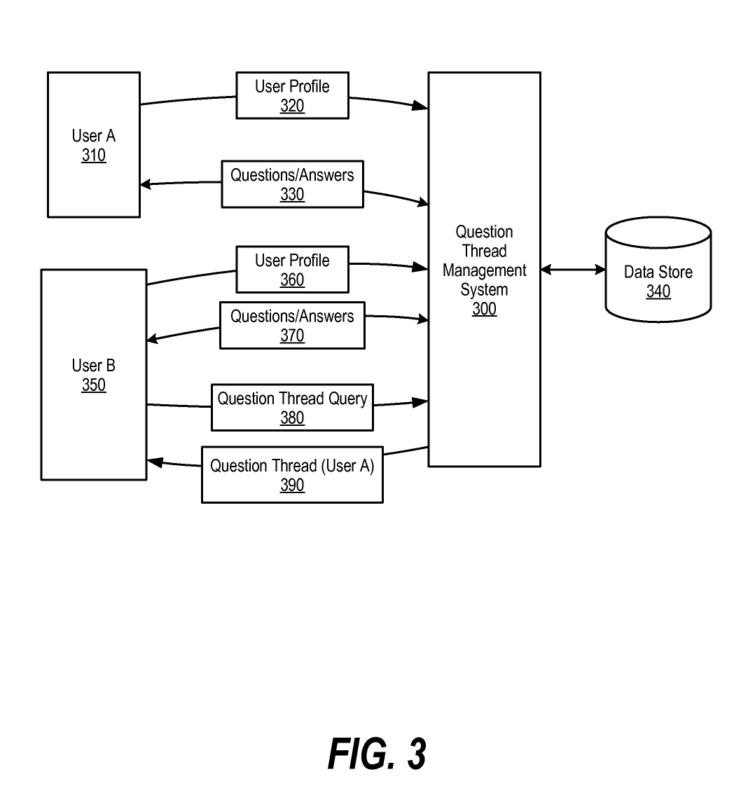

FIGS. 3-9 depict an approach that can be executed on an information handling system, such as those shown in FIGS. 1-2. A question thread management system accumulates questions and answers corresponding to users into question threads, and then provides the question threads to other users on request based upon various criteria. During the accumulation phase, the question thread management system records questions from a user, answers to the user (e.g., relevant URLs, other user's answers, etc.), and justifications from the user (reasons that the user asks a particular question). Next, the question thread management system classifies the question thread based upon profile attributes included in the user's profile (e.g., user expertise level). In turn, the question thread management system provides the question thread to other users requesting assistance in their questioning research.

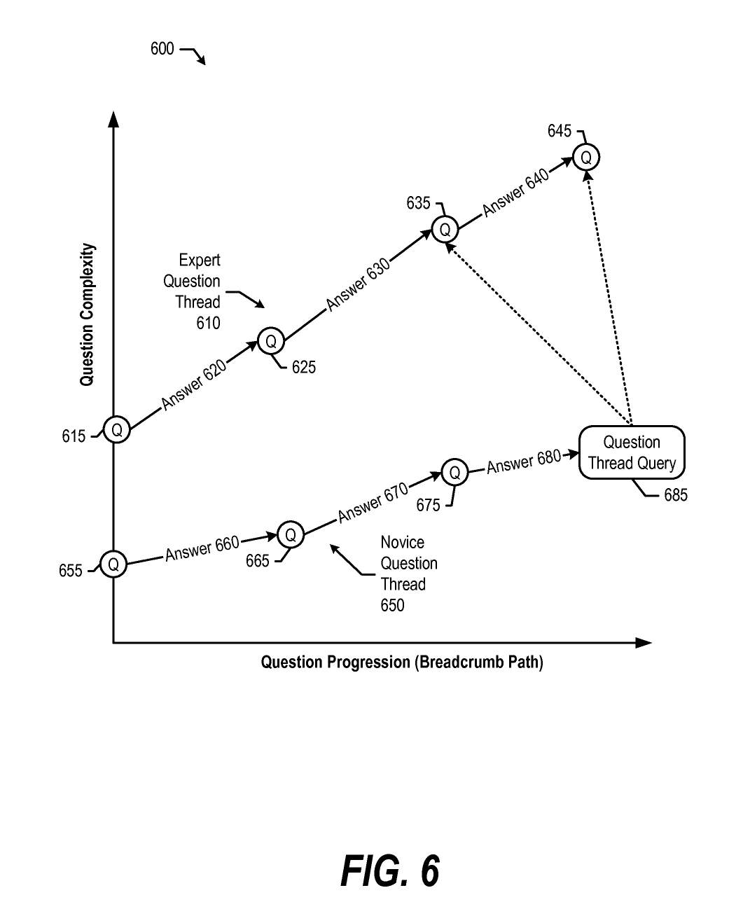

In one embodiment, the question thread management system graphically depicts the question threads. In this embodiment, the question thread management system may perform linguistic analysis, semantic analysis, statistical data/text mining, etc., to identify question/answer complexity levels and graph the questions/answers accordingly. In this embodiment, the question thread management system may also perform linguistic analysis, semantic analysis, statistical data/text mining, etc. to match respective questions between different question threads (see FIG. 6 and corresponding text for further details). As such, the question thread management system improves question/answer completeness and provides visual guidance to a user while exploring a topic. In another embodiment, the question thread may be displayed in a textual manner rather than a graphical manner.

FIG. 3 is a depiction of a diagram showing a question thread management system accumulating questions and answers into question threads and providing a question thread in response to receiving a query request. Question thread management system 300 accumulates questions and answers into question threads, which are stored in data store 340. Question thread management system 300 associates the question threads with user profiles corresponding to users asking the questions and receiving answers. The user profiles include profile attributes, such as the user's expertise level, with which question thread management system 300 utilizes to match stored question threads with query requests and provide relevant question threads to requesting users. As those skilled in the art can appreciate, a query request may be any type of request received from a user that requests information from question thread management system 300.

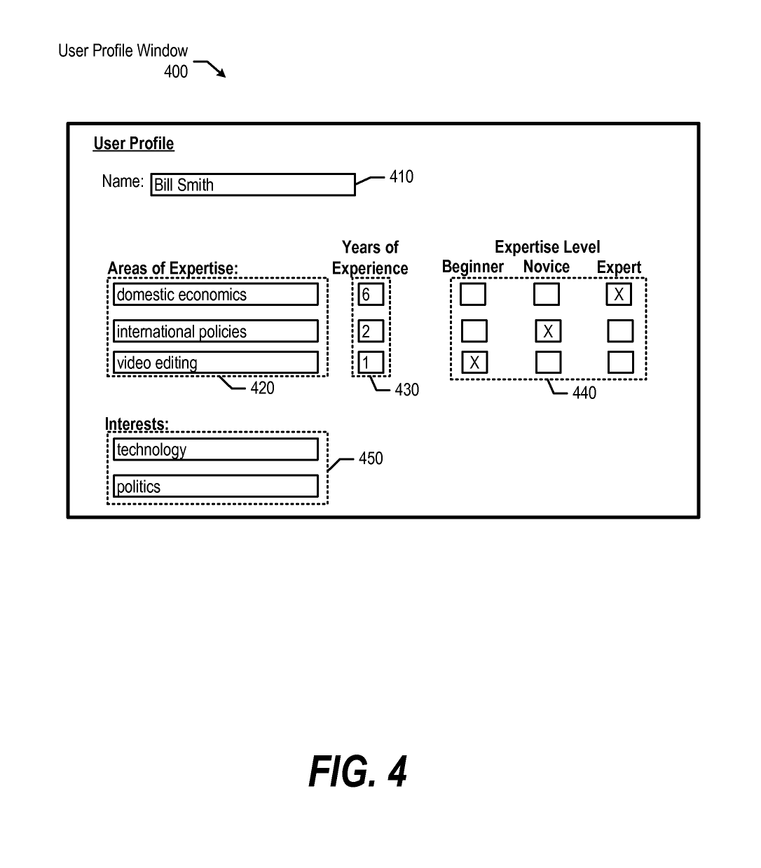

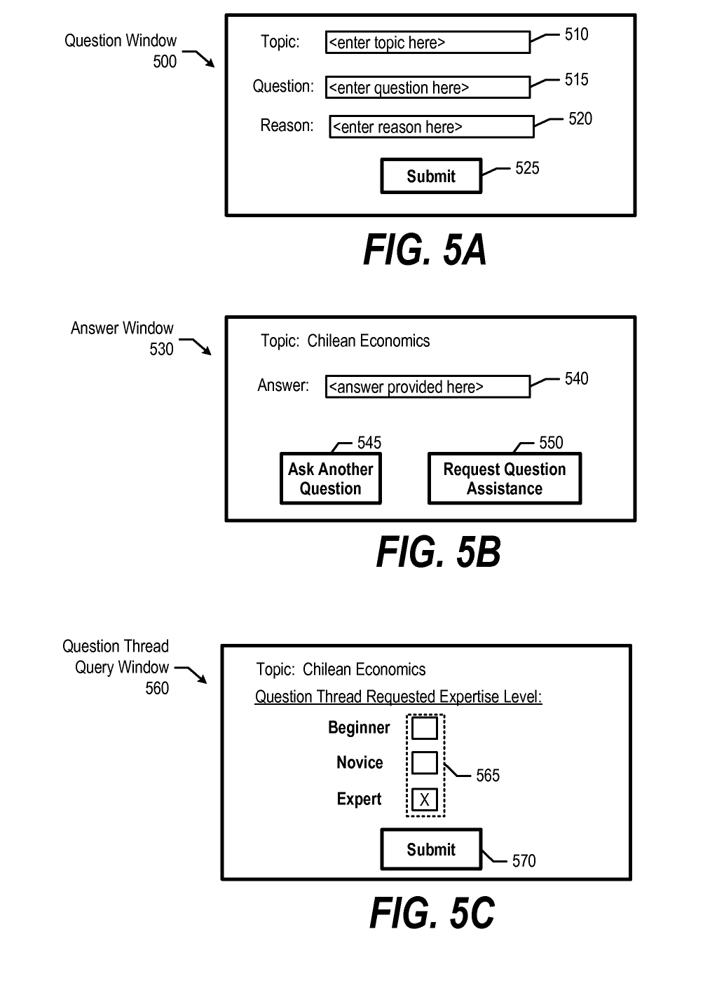

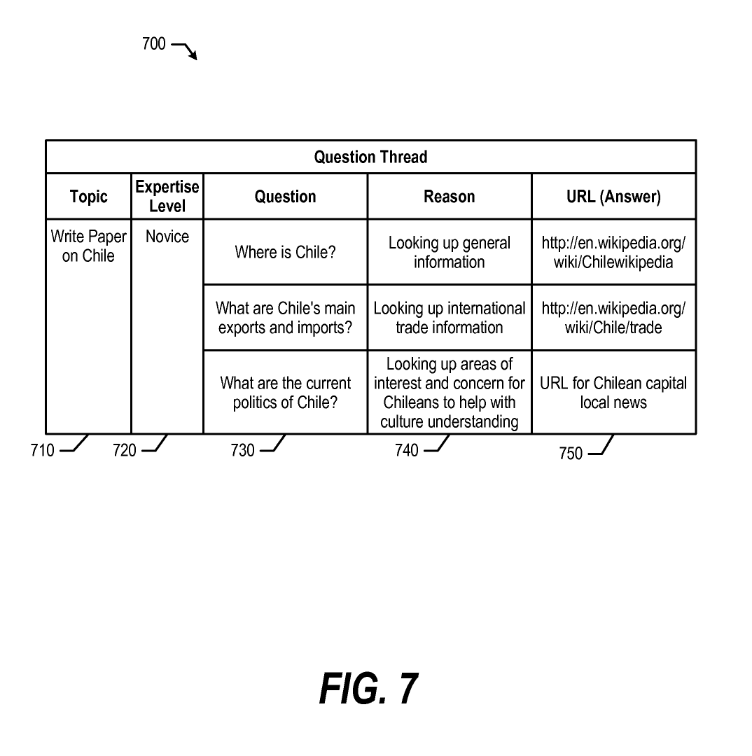

User A 310 initiates a question and answer session with question thread management system 300 and provides user profile 320. Question thread management system 300, in one embodiment, may provide a user profile window such as that shown in FIG. 4, which user A 310 fills in with profile attributes. In turn, question thread management system 300 stores the user profile in data store 340 and initiates a question and answer thread with user A 310 via questions/answers 330. In one embodiment, questions/answers 330 are exchanged via interface windows such as those shown in FIGS. 5A and 5B. Once complete, question thread management system 300 stores the questions, answers, user A 310's expertise level included in the user profile, and other pertinent data as a question thread in data store 340 (see FIG. 7 and corresponding text for further details). In another embodiment, a default profile may be used in the event that the user has not entered a profile. In yet another embodiment, an administrator may supply the profile for the user based on organizational or resume information.

User B 350 also initiates a question and answer session with question thread management system 300 and provides user profile 360. User B 350 commences in a question and answer session with question thread management system 300 via questions/answers 370. At some point, user B 350 may require assistance on identifying subsequent questions to ask and, as such, user B 350 sends question thread query 380 to question thread management system 300. In one embodiment, user B 350 uses an interface window such as that shown in FIG. 5C to provide request attributes to question thread management system 300. For example, a doctor may be meeting with a patient and wish to use question thread management system 300 to log questions asked and answers obtained from the patient. In this example, the doctor logs her years of experience, areas of expertise, and areas of research (user profile 320), and begins asking questions regarding certain symptoms and notes the answers received from the patient (questions/answers 330). Continuing with this example, the doctor reaches a point where the doctor can branch her questions in one direction or another. As such, the doctor sends question thread query 380 to question thread management system 300 to review other doctors' question threads corresponding to similar patient symptoms.

Question thread management system 300 uses the query attributes included in question thread query 380 to identify relevant question threads previously stored in data store 340 based upon their associated user profile. Question thread management system 300, in turn, identifies the question thread generated by user A 310 question/answer sessions and provides question thread 390 to user B 350.

In one embodiment, user A 310's question thread 390 may displayed to user B 350 in a graphical manner. In another embodiment, question thread 390 may be displayed to user B 350 in a textual manner. In yet another embodiment, question thread 390 may be graphically displayed concurrently with user B 350's question thread and may also show similarities/differences between the two question threads (see FIG. 6 and corresponding text for further details). In yet another embodiment, answers to questions included in question thread 390 are optionally available to view by user B 350.

FIG. 4 depicts a diagram of a user profile window that allows a user to create a user profile and enter profile attributes. In one embodiment, question thread management system 300 provides user profile window 400 to a user onto which the user enters profile attributes. The user enters the user's name or user ID in text box 410, and proceeds to fill out areas of expertise (boxes 420), years of experience (boxes 430), and self-proclaimed or validated expertise level (boxes 440). In one embodiment, the question thread management system utilizes more expertise levels than a beginner, novice, or expert level based upon various criteria. In this embodiment, the question thread management system may qualify a user as an expert in a particular subject with an interest in different but related subject in which the user has little knowledge. For example, the user might be an expert fly fisherman, and is searching for information on lake water conditions in June in the mid-West. In another example, the question thread management system may generate sub-expertise levels based upon years of experience, such as “Novice 1,” “Novice 2,” etc.

In one embodiment, the user enters the user's “interests” in boxes 450. In this embodiment, the user's interests may be utilized by the question thread management system to map to levels of expertise as question threads branch into a wider knowledge base.

When the user commences a question/answer session with question thread management system 300, the question thread management system creates question threads and assigns an expertise level to the question threads based upon the profile attributes entered in user profile window 400. For example, referring to FIG. 4, when “Bill Smith” generates a question thread relating to domestic economics, the question thread management system associates an “Expert” expertise level to the question thread. Similarly, when Bill Smith generates a question thread relating to video editing, the question thread management system associates a “beginner” expertise level to the particular question thread.

FIG. 5A is a depiction of a question window that allows a user to enter a question. In one embodiment, the question thread management system displays question window 500 to a user, which allows the user to enter a topic in text box 510, a question in text box 515, and a reason for asking the particular question in text box 520. For example, a user may wish to write a research paper about news events in Chile to discuss Chile's culture in more detail. In this example, the user enters “Chile Economics” in text box 510, “Chile News?” in text box 515, and “Looking up areas of interest and concern for Chileans to help with culture understanding” in text box 520. When the user is finished entering information in question window 500, the user selects submit button 525 and the question thread management system logs the user's input into a question thread (see FIG. 7 and corresponding text for further details).

FIG. 5B depicts a diagram of an answer window that provides an answer (e.g., URL) to a question previously asked by the user. When the question thread management system receives a question from a user (discussed above), the question thread management system provides an answer to the user such as with answer window 530. Answer window 530 includes an answer to the user's question in box 540, such as a website location. The question thread management system also stores the answer in the user's question thread that is being generated during the question/answer session. In an embodiment where the user receives answers from another source (e.g., asking a patient questions and receiving answers from the patient), the question thread management system may provide an answer window in which the user enters the other source's answers.

The user may view the answer in box 540 and choose to ask another question (selection button 545) or request the question thread management system for question assistance (selection button 550). When the user selects button 550, the question thread management system provides a question thread query window to a user (see FIG. 5C and corresponding text for further details).

FIG. 5C depicts a question thread query window that allows a user to request a question thread based upon a topic and a particular expertise level. The question thread management system provides question thread query window 560 to a user when the user requests question assistance. The user provides request attributes by selecting one or more of boxes 565 to request an expertise level of a question thread (corresponding to a previous user's expertise level) to the question thread management system. For example, the user may not have much experience in a particular subject matter and wish to view questions asked by experts pertaining to the same subject matter. In another example, a user may be performing educational research and wish to view questions asked by users with a beginner expertise level.

The user selects submit button 570 when the user finishes selecting one or more of boxes 565. In turn, the question thread management system uses the request attributes of the requested expertise levels and topic to identify and analyze relevant question threads previously stored in data store 340.

FIG. 6 is a depiction of a diagram graphically depicting question threads. The question thread management system accumulates questions and answers into question threads, which are linked to user profiles and various profile attributes (e.g., the user's expertise level). In one embodiment, the question threads are graphically depicted for a user to view. FIG. 6 shows an embodiment of the question threads depicted in an X-Y coordinate form with question complexity represented on the Y-axis and question progression represented on the X-axis. Question complexity may take particular linguistic attributes into account, including but not limited to vocabulary and terminology used, type of technology assumed or implied, etc. As those skilled in the art can appreciate, the question thread management system may graphically represent the question threads using other graphical approaches, such as a tree view, bars, scatter, bubble, radar, textual breadcrumbs, etc.

Graph 600 shows expert question thread 610, which includes questions 615, 625, 635, and 645 generated by a user with an “expert” expertise level. Answers 620, 630, and 640 are answers provided by the question thread management system (or other users). In one embodiment, the questions and answers may be represented as icons that a user may select to read the actual question or answer. In another embodiment, the actual questions and answers may be displayed on graph 600.

Graph 600 also shows novice question thread 650, which corresponds to a user having a “novice” expertise level in the particular subject matter. As can be seen, a novice asked question 655 that resulted in answer 660. In turn, the novice user asked question 665, which resulted in answer 670. Next, the novice user asked question 675 that resulted in answer 680.

After receiving answer 680, the novice user is unaware of other questions to ask and, therefore, requests a question thread query (question thread query 685), such as using question thread query window 560 shown in FIG. 5C. In one embodiment, the question thread management system displays graph 600 and shows novice question thread 650, expert question thread 610, and similarities/differences between the two question threads. The example shown in FIG. 6 shows the differences, or next questions to ask, which are shown in dashed arrows. In one embodiment, the question thread management system may perform linguistic analysis, semantic analysis, statistical data/text mining, etc. to match questions included in question thread 650 to questions included in question thread 610 and indicate which questions to ask next.

As such, the novice user can review questions 635 and/or question 645 to determine next questions to ask. In one embodiment, question thread 610's questions and answers may be represented as icons that a user may select to read the actual question or answer. In another embodiment, the actual questions and answers may be displayed on graph 600. In these embodiments, when the user selects a next question from question thread 610, the question thread management system may display a user interface window, such as question window 500 shown in FIG. 5A, that includes the selected question in box 515. In turn, the user selects submit button 525 to ask the next question. In another embodiment, question window 500 may provide the user with a drill down option in box 515 that shows several different questions included in question thread 610 from which the user may select as the next question.

FIG. 7 is a depiction of a diagram showing a table that includes information accumulated into a question thread. Question thread 700 is shown in tabular form and was generated by question thread management system 300 during a question/answer session. Column 710 includes a topic of the question thread (e.g., the topic entered in text box 510 of FIG. 5A. Column 720 includes a user expertise level of the user that participated in the question/answer session (e.g., the expertise level entered in text boxes 440 shown in FIG. 4 relative to the particular topic). In one embodiment, the areas of expertise are linked to the discussion topics by mapping identifiers to the profile and subsequent questions related to specific topics.

Columns 730, 740, and 750 include questions, reasons for the questions (e.g., to log the user's train of thought), and answers, respectively, in bread crumb format of the question/answer session. As such, question thread 700 may be graphically displayed such as that shown in FIG. 6. In one embodiment, the question thread management system associates complexity levels to questions and answers by performing linguistic analysis, semantic analysis, statistical data/text mining, etc., on the questions and answers. In another embodiment, question thread 700 may include separate columns for an answer, evidence, and confidence for a particular question. For example, in response to the question “Where is Chile?” the question thread management system would respond with “South America”, or perhaps a range of latitude and longitude information. In this example, the question thread management system would also offer a confidence level and the “evidence” for the answer by providing a web page link.

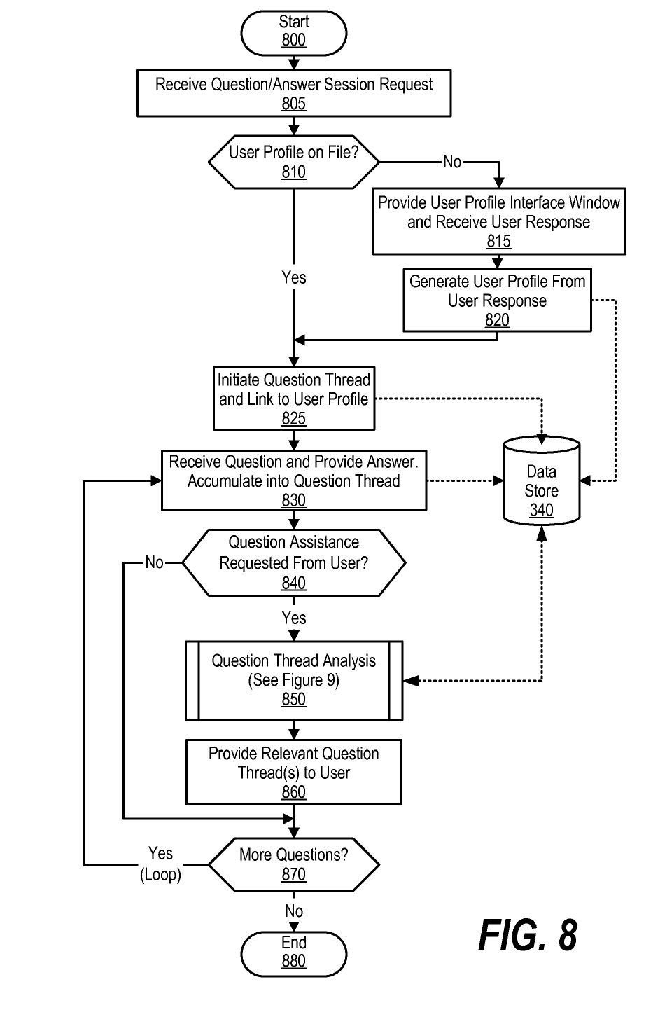

FIG. 8 is a depiction of a flowchart showing the logic used by the question thread management system to manage question threads. Question thread management system processing commences at 800, whereupon the question thread management system process receives a question/answer session request at step 805.

The question thread management system process determines whether the requesting user has a user profile stored in data store 340 (decision 810). If the user previously created a user profile, decision 810 branches to the “Yes” branch, bypassing user profile creation steps.

On the other hand, if the user has not created a user profile, decision 810 branches to the “No” branch, whereupon the question thread management system process provides a user interface window that allows the user to enter profile attribute information, such as that shown in FIG. 4 (step 815). At step 820, the question thread management system generates and stores a user profile in data store 340.

At step 825, the question thread management system process initiates a question thread, such as by providing the user with a question window shown in FIG. 5A. The user enters a question in the question window and the question thread management system process provides an answer to the user, such utilizing an answer window shown in FIG. 5B (or an answer window for the user to fill in an answer received from another source, step 830). The question thread management system accumulates the question and answer into the question thread that is initiated in data store 340.

A determination is made as to whether the user would like question assistance, such as by depressing button 550 shown in FIG. 5B (decision 840). For example, an attorney preparing to defend a client on a particular charge begins to formulate questions and comes to a point whether the attorney wishes to review past cases and the representing attorney's line of questioning.

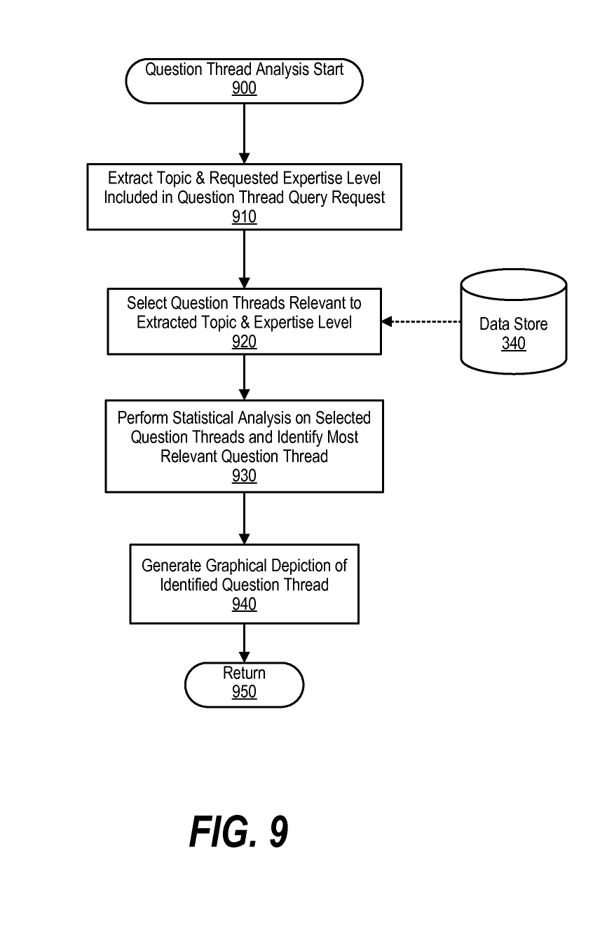

If the user requests question assistance (e.g., a query request), decision 840 branches to the “Yes” branch, whereupon the question thread management system process analyzes question threads stored in data store 340 based upon their user profile (e.g., expertise level) to identify question threads that are suitable to provide to the requesting user (pre-defined process block 850, see FIG. 9 and corresponding text for further details). At step 860, the question thread management system process provides the identified relevant question thread to the user. In one embodiment, the question thread management system process graphically displays the relevant question thread, such as that shown in FIG. 6. On the other hand, if the user does not require question assistance at this time, decision 840 branches to the “No” branch, bypassing question thread analysis.

A determination is made as to whether the user wishes to ask more questions, either from the user's knowledge or by selecting a question from the displayed question thread (decision 870). If the user wishes to ask another question, decision 870 branches to the “Yes” branch, which loops back to process another question from the user. This looping continues until the user is finished asking questions, at which point decision 870 branches to the “No” branch, whereupon processing ends at 880.

FIG. 9 is a depiction of a flowchart showing the logic used by the question thread management system to locate acceptable question threads to provide to a user based upon a user profile. Question thread management system processing commences at 900, whereupon the question thread management system extracts a topic and requested expertise level (request attributes) from a query request (received from steps in FIG. 8) at step 910. In one embodiment, the user may not provide a requested expertise level and, in this embodiment, the question thread management system identifies the expertise level of the requesting user (user expertise level) from the user's profile and uses the user's expertise level as request attributes to search for similar question threads (discussed below). In one embodiment, the question thread management system may automatically generate request attributes based on user history or a user's resume. In another embodiment, the question thread management system performs linguistic analysis to determine topic request attributes of the query request. At step 920, the question thread management system selects question threads from data store 340 that correspond to the topic and expertise level. For example, the user may wish to view question threads generated by users with an “expert” expertise level covering a topic of tornadoes in America. The question thread management system identifies relevant question threads and performs statistical analysis on the relevant question threads in order to identify the most relevant question thread (step 930). For example, the question thread management system may select from various or regional meteorologists profiles and provide a selection or a partial selection of a particular question thread, for which the user may select. In one embodiment, the question thread management system may present available question threads related to a topic and allow the user to select a preferred question thread based on, for example, an abstract on answers found.

The question thread management system generates a graphical depiction of the question thread at step 940. In one embodiment, the question thread management system includes a graphical depiction of the user's question thread and the most relevant question thread. In yet another embodiment, the question thread management system identifies similarities and differences between the user's question thread and the most relevant question thread (see FIG. 6 and corresponding text for further details). Processing returns at 950.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method of aggregating question threads, implemented by an information handling system, comprising:
accumulating a first set of questions corresponding to a first user;
classifying the first set of questions into a first question thread, the first question thread corresponding to a first user profile of the first user;
receiving a query request corresponding to a second user; and
displaying one or more questions belonging to the first question thread in response to comparing one or more request attributes included in the query request corresponding to the second user with one or more first profile attributes included in the first user profile.

2. The method of claim 1 wherein the comparing further comprises:
determining a requested expertise level included in the one or more request attributes; and
matching the requested expertise level to a first user expertise level included in the first user profile.

3. The method of claim 1 wherein the comparing further comprises:
retrieving a user expertise level of the second user from the second user profile; and
comparing the second user expertise level to a first user expertise level included in the first user profile.

4. The method of 1 further comprising:
prior to receiving the query request:
accumulating a second set of questions corresponding to the second user;
classifying the second set of questions into a second question thread, the second question thread corresponding to a second user profile of the second user; and
graphically depicting the second question thread.

5. The method of 4 further comprising:
analyzing the second question thread against the first question thread;
identifying one or more next questions included in the first question thread in response to the analysis, the one or more next questions not included in the second question thread; and
providing the one or more next questions to the second user.

6. The method of claim 5 further comprising:
graphically depicting the first question thread with the second question thread that indicates the one or more next questions.

7. The method of claim 5 further comprising:
graphically depicting one or more similarities between the first question thread and the second question thread.

8. An information handling system comprising:
one or more processors;
a memory coupled to at least one of the processors;
a set of computer program instructions stored in the memory and executed by at least one of the processors in order to perform actions of:
accumulating a first set of questions corresponding to a first user;
classifying the first set of questions into a first question thread, the first question thread corresponding to a first user profile of the first user;
receiving a query request corresponding to a second user; and
displaying one or more questions belonging to the first question thread in response to comparing one or more request attributes included in the query request corresponding to the second user with one or more first profile attributes included in the first user profile.

9. The information handling system of claim 8 wherein the processors perform additional actions comprising:
determining a requested expertise level included in the one or more request attributes; and
matching the requested expertise level to a first user expertise level included in the first user profile.

10. The information handling system of claim 8 wherein the processors perform additional actions comprising:
retrieving a user expertise level of the second user from the second user profile; and
comparing the second user expertise level to a first user expertise level included in the first user profile.

11. The information handling system of 8 wherein the processors perform additional actions comprising:
prior to receiving the query request:
accumulating a second set of questions corresponding to the second user;
classifying the second set of questions into a second question thread, the second question thread corresponding to a second user profile of the second user; and
graphically depicting the second question thread.

12. The information handling system of 11 wherein the processors perform additional actions comprising:
analyzing the second question thread against the first question thread;
identifying one or more next questions included in the first question thread in response to the analysis, the one or more next questions not included in the second question thread; and
providing the one or more next questions to the second user.

13. The information handling system of claim 12 wherein the processors perform additional actions comprising:
graphically depicting the first question thread with the second question thread that indicates the one or more next questions.

14. The information handling system of claim 12 wherein the processors perform additional actions comprising:
graphically depicting one or more similarities between the first question thread and the second question thread.

15. A computer program product stored in a computer readable storage medium, comprising computer program code that, when executed by an information handling system, causes the information handling system to perform actions comprising:
accumulating a first set of questions corresponding to a first user;
classifying the first set of questions into a first question thread, the first question thread corresponding to a first user profile of the first user;
receiving a query request corresponding to a second user; and
displaying one or more questions belonging to the first question thread in response to comparing one or more request attributes included in the query request corresponding to the second user with one or more first profile attributes included in the first user profile.

16. The computer program product of claim 15 wherein the information handling system performs further actions comprising:
determining a requested expertise level included in the one or more request attributes; and
matching the requested expertise level to a first user expertise level included in the first user profile.

17. The computer program product of claim 15 wherein the information handling system performs further actions comprising:
retrieving a user expertise level of the second user from the second user profile; and
comparing the second user expertise level to a first user expertise level included in the first user profile.

18. The computer program product of 15 wherein the information handling system performs further actions comprising:
prior to receiving the query request:
accumulating a second set of questions corresponding to the second user;
classifying the second set of questions into a second question thread, the second question thread corresponding to a second user profile of the second user; and
graphically depicting the second question thread.

19. The computer program product of 18 wherein the information handling system performs further actions comprising:
analyzing the second question thread against the first question thread;
identifying one or more next questions included in the first question thread in response to the analysis, the one or more next questions not included in the second question thread; and
providing the one or more next questions to the second user.

20. The computer program product of claim 19 wherein the information handling system performs further actions comprising:
graphically depicting the first question thread with the second question thread that indicates the one or more next questions.
